(19) United States
(12) Patent Application Publication
(10) Pub. No.: US 2009/0132435 A1
(43) Pub. Date: May 21, 2009

(54) POPULARITY BASED LICENSING OF USER GENERATED CONTENT

(75) Inventors: Tobin R. Titus, Issaquah, WA (US); Ernest A. Booth, Bellevue, WA (US); Erik Porter, Kirkland, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/943,618

(22) Filed: Nov. 21, 2007

(51) Int. Cl. G06Q 10/00

(52) U.S. Cl. 705/400

(57) ABSTRACT

Technologies are described herein for providing popularity-based licensing of user-generated content. A selection of a popularity measure is received. A value of the popularity measure is determined. A price of a user-generated content item is determined based on the value of the popularity measure. A license including the price of the user-generated content item is generated.

### BACKGROUND

In recent years, massively multiplayer online (“MMO”) computer applications, such as massively multiplayer role-playing games (“MMORPGs”), have become extremely popular not only with serious gamers, but also with casual gamers and other Internet users. One example of a MMO computer application enables a participant to create and develop a fictional character in a virtual world. The fictional character is usually associated with an avatar or some other visual representation that enables other participants to recognize the particular fictional character. A given participant may develop, among other things, a storyline, a reputation, and attributes of her fictional character by interacting in the virtual world via the fictional character. Other examples of MMO computer applications may not involve the creation of a virtual world representation of the participant.

The virtual world typically includes an environment with a variety of virtual locations containing a variety of virtual objects. In some cases, the virtual locations and the virtual objects mimic realistic locations and objects, while in other cases, the virtual locations and virtual objects are fanciful creations. MMO computer applications generally permit the fictional character to travel across the virtual locations and interact with the virtual objects and other fictional characters.

One significant factor in the growth of MMO computer applications has been the ability for participants to create and distribute their own content to other participants within the MMO environment. Common types of user-generated content include multimedia files, such as text, picture, audio, and video files, as well as application plug-ins that may be utilized within a MMO computer application to provide additional functionality. An example of an application plug-in may be a graphical user interface (“GUI”) embedded within a social networking website that enables participants of the website to rate movies. In MMO environments, user-generated content may also include avatars and three-dimensional virtual objects, such as cars, buildings, and the like.

There currently exists no convenient way for a content creator to license her content to other participants within the MMO environment. In many cases, the content creator is limited to providing her content for free. More sophisticated content creators may be able to create and enforce licensing terms separate and apart from the MMO computer application. However, the typical recreational content creator does not have the ability and/or resources to generate and enforce licensing terms.

It is with respect to these considerations and others that the disclosure made herein is presented.

### SUMMARY

Technologies are described herein for providing popularity-based licensing of user-generated content. In particular, through the utilization of the technologies and concepts presented herein, a content creator or other user may vary licensing fees in accordance with at least one popularity measure. The popularity measure may be based on the popularity of one or more of the user-generated content, the content creator of the user-generated content, and/or the recipients purchasing and/or accessing the user-generated content. By varying the licensing fees according to the popularity measure, demand for the user-generated content and revenue resulting from the sale of the user-generated content can be maximized by increasing or decreasing licensing fees in accordance with changes to the popularity measure.

According to one aspect presented herein, a computer program provides for popularity-based licensing of user-generated content. The computer program receives a selection of a popularity measure. Exemplary popularity measures include a content popularity measure, which indicates a popularity of a user-generated content item, a content creator popularity measure, which indicates a popularity of a participant who created the user-generated content item, and a recipient popularity measure, which indicates a participant who is purchasing and/or accessing the user-generated content item. The computer program determines a value of the selected popularity measure, and determines a price of the user-generated content item based on the value of the popularity measure. Once the price is determined, the computer program generates a license that includes the price of the user-generated content item. Accordingly, the user-generated content item can be licensed to other users, such as participants of a virtual world, at the price specified in the license. The process of determining the value of the popularity measure and determining the price of the user-generated content item may be repeated as many times as needed to account for dynamic changes in the value of the popularity measure.

It should be appreciated that although the features presented herein are described in the context of user-generated content within a MMO computer application, these features may be utilized with user-generated content configured for any suitable application including, but not limited to, other types of computer applications (e.g., a word processor) as well as online social communities. It should also be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a network architecture diagram showing aspects of a network architecture capable of implementing a virtual world;

FIG. 2 is a screen display diagram showing an illustrative screenshot of a licensing interface, in accordance with one embodiment;

FIGS. 3 and 4 are screen display diagrams showing illustrative screenshots of a licensing wizard provided by the licensing interface, in accordance with one embodiment;

FIG. 5 is a screen display diagram showing an illustrative screenshot of an upload license interface provided by the licensing interface, in accordance with one embodiment;

FIGS. 6A, 6B, and 6C are flow diagrams showing illustrative processes for determining or adjusting a price of a participant-generated content item according to different popularity measures, in accordance with one embodiment; and

FIG. 7 is a computer architecture diagram showing aspects of an illustrative computer hardware architecture for a computing system capable of implementing the embodiments presented herein.

### DETAILED DESCRIPTION

The following detailed description is directed to technologies for popularity-based licensing of user-generated content. Through the utilization of the technologies and concepts presented herein, a licensing interface is provided that enables a user to select and define popularity-based licensing of user-generated content. The popularity measure may be based on the popularity of one or more of the user-generated content, the content creator of the user-generated content, and the recipient purchasing and/or accessing the user-generated content. While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

Solely for illustrative purposes, the licensing interface is described herein in the context of a virtual world. Further, the licensing interface is described herein with reference to participant-generated content created by participants of the virtual world. It should be appreciated that the licensing interface is not so limited and may be utilized in a variety of other contexts and with any type of content. In particular, the licensing interface may be utilized with any content that is distributed through a content and/or service provider. Examples of content may include, but are not limited to, multimedia content, such as text, pictures, audio, video, and combinations thereof, as well as computer applications, such as application plug-ins that add new functionality to the content and/or service provider. Other examples of content include avatars and three-dimensional virtual objects. Examples of content and/or service providers may include, but are not limited to, social network websites (e.g., FACEBOOK from FACEBOOK INCORPORATED) and multimedia distribution services (e.g., ZUNE MARKETPLACE from MICROSOFT CORPORATION, ITUNES from APPLE INCORPORATED).

As used herein, the term virtual world refers to a computer-implemented environment, which may include simulated, lifelike environments as well as fanciful, non-existing environments. Exemplary virtual worlds may include any massively multiplayer online (“MMO”) computer application including, but not limited to, massively multiplayer online role-playing games (“MMORPGs”), virtual social communities, and virtual reality computer applications. In one embodiment, the MMO computer application simulates a real world environment. For example, the virtual world may be defined by a number of rules, such as the presence of gravity or the lack thereof. In other embodiments, the MMO computer application includes a fanciful environment that does not simulate a real world environment.

The virtual world is generally inhabited by avatars, which are virtual or symbolic representations of real world participants (hereinafter referred to as participants). As such, each avatar is typically associated with and controlled by a particular participant. Avatars may include two-dimensional and/or three-dimensional images. Through the virtual world, the avatars may interact with other avatars, as well as with virtual objects. Virtual objects may include virtual representations of real world objects, such as houses, cars, billboards, clothes, and soda cans, as well as fanciful creations, such as a teleportation machine or a flying car. According to exemplary embodiments, one or more virtual objects and one or more avatars in the virtual world are capable of providing an advertisement. The avatars and the virtual objects utilized in the virtual world may or may not be animated images.

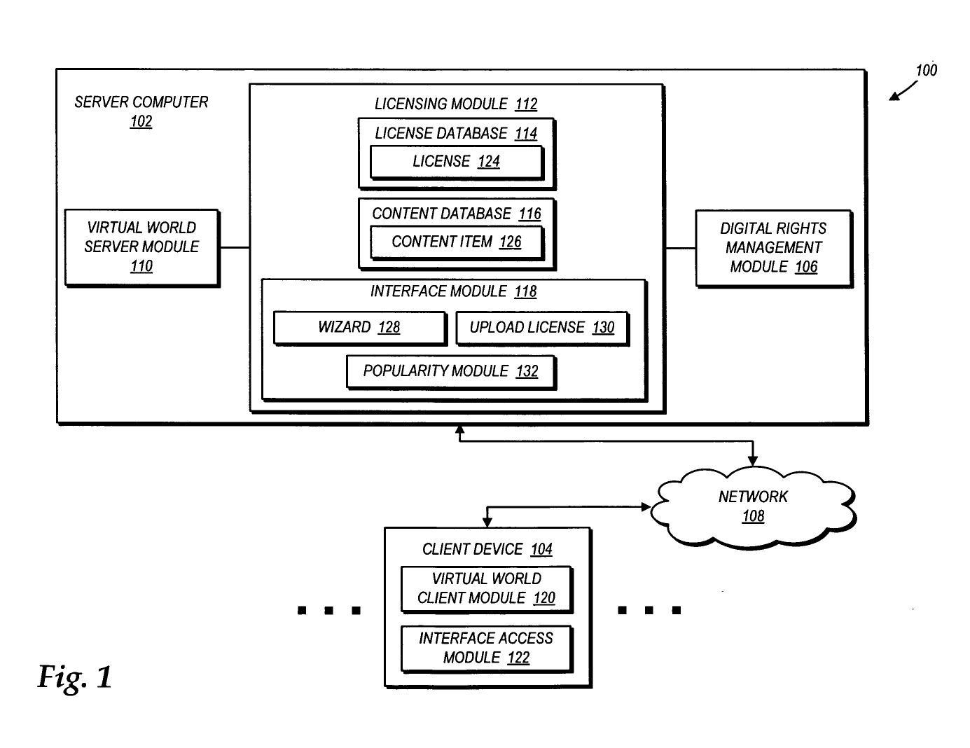

In the following detailed description, references are made to the accompanying drawings that form a part hereof, and which are shown by way of illustration specific embodiments or examples. Referring now to the drawings, in which like numerals represent like elements through the several figures, aspects of a computing system and methodology for popularity-based licensing of participant-generated content will be described. In particular, FIG. 1 illustrates a simplified network architecture 100 for a virtual world. The network architecture 100 shown in FIG. 1 includes a server computer 102 and a client device 104, both of which are operatively coupled via a network 108. The network 108 may be any suitable network, such as a local area network (“LAN”) or the Internet. Although only one client device 104 is illustrated in FIG. 1, the network architecture 100 may include multiple client devices in any suitable network configuration.

The client device 104 may be any suitable processor-based device, such as a computer or a gaming device. Exemplary gaming devices include the XBOX and the XBOX 360 from MICROSOFT CORPORATION, the WII from NINTENDO COMPANY, LIMITED, and the PLAYSTATION 3 and the PSP from SONY CORPORATION. Although not so illustrated in FIG. 1, the client device 104 may be coupled to any suitable peripheral devices to enable the participant to experience and interact with the virtual world. Exemplary peripheral devices may include an input device, such as a keyboard, a mouse, a microphone, and a game controller, and an output device, such as a display and speakers. Some peripheral devices may even provide both input and output functionality. For example, a game controller may provide vibration feedback.

As shown in FIG. 1, the client device 104 includes a virtual world client module 120, which interacts with the virtual world server module 110 executing on the server computer 102. In particular, the virtual world client module 120 may receive and process data from virtual world server module 110 and output the data to output devices coupled to the client device 104. Further, the virtual world client module 120 may receive data from input devices coupled to the client device 104 and transmit the data to the virtual world server module 110. The client device 104 may also include an interface access module 122, as illustrated in FIG. 1.

The virtual world client module 120 may include any suitable component for accessing the virtual world server module 110. In one example, the virtual world client module 120 may be a computer application configured to locally provide at least a portion of the virtual world for the client device 104. In this way, the amount of data retrieved from the server computer 102 by the client device 104 to generate the virtual world may be reduced. In another example, the virtual world client module 120 may be a web browser configured to retrieve the virtual world from the virtual world server module 110. Since many public computers, such as those found in Internet cafes, commonly have a web browser installed and prohibit the installation of new computer applications, providing participants a way to access the virtual world via the web browser may provide greater accessibility and convenience.

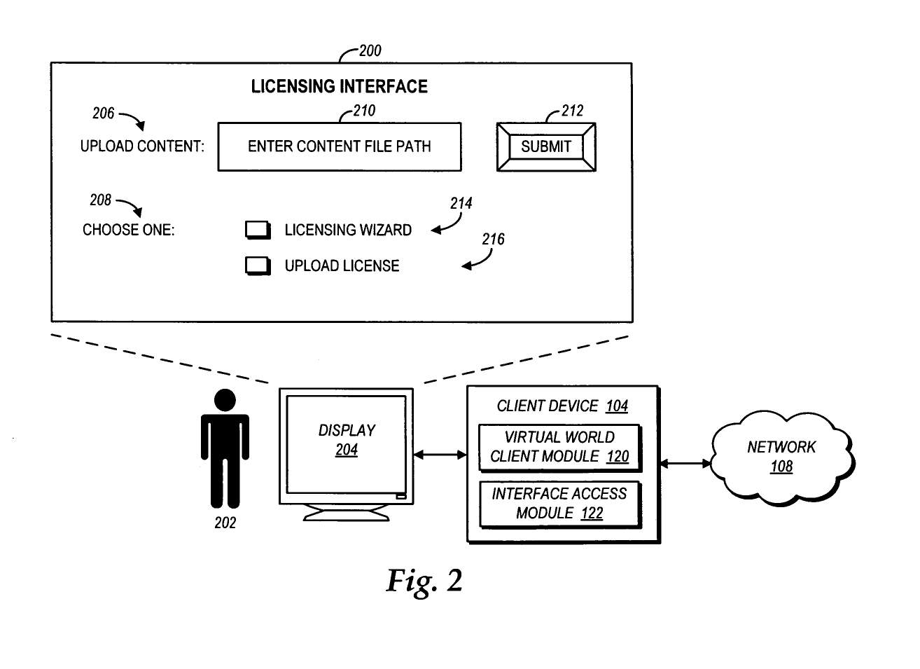

As shown in FIG. 1, the server computer 102 includes a virtual world server module 110, a licensing module 112, and a digital rights management (“DRM”) module 106. The virtual world server module 110 generally administers the virtual world and serves as a conduit between multiple client devices, including the client device 104. The licensing module 112 includes a license database 114, a content database 116, and an interface module 118. The content database 116 stores participant-generated content, such as a participant-generated content item 126. In one embodiment, the participant-generated content item 126 is uploaded from the client device 104 to the content database 116. The license database 114 stores one or more licenses, such as a license 124. In one embodiment, the license 124 is created via a licensing wizard 128 provided by the interface module 118. The licensing wizard 128 may provide a series of dialogs and predefined options that guide the content creator through a process to generate the license 124. In particular, the series of dialogs and predefined options may include an option to select a license fee structure corresponding with a popularity measure as determined by a popularity module 132. In another embodiment, the license 124 is uploaded from the client device 104 via the upload license interface 130. The operation of the interface module 118 is described in greater detail below with reference to FIGS. 2, 3, 4, 5, and 6.

In one embodiment, the enforcement of the licenses, such as the license 124, stored in the license database 114, with respect to distributing the participant-generated content item 126, is facilitated by way of the digital rights management (“DRM”) module 106. In particular, DRM may be utilized to manage, among other distribution and usage factors, the number of computing devices that can access the participant-generated content item 126, the number of times that the participant-generated content item 126 can be accessed, the length of time for which the participant-generated content item 126 can be accessed, the number of times that the participant-generated content item 126 can be transferred, the number of times that the participant-generated content item 126 can be copied, and the number of times that a computer-readable medium (e.g., CD-ROM, DVD-ROM) containing the participant-generated content item 126 can be created. DRM may also determine the amount of money to be charged for performing these distribution and usage factors. Each of these distribution and usage factors may be defined by the content creator via the interface module 118. It should be appreciated that other suitable methods for enforcing the licenses stored in the license database 114 may also be used.

In one embodiment, the DRM module 106 is a web server. An exemplary DRM process executed by the DRM module 106 may operate as follows for the participant-generated content item 126 (e.g., a multimedia file). First, the DRM module 106 encrypts the content item 126 with a key. The encrypted content item 126 includes a uniform resource locator (“URL”) pointing to the DRM module 106. The encrypted content item 126 may be provided to the virtual world, and a participant may obtain the encrypted content item 126 at the client device 104. When the participant attempts to access the encrypted content item 126, the participant is directed to the DRM module 106 where the participant can purchase or otherwise obtain the license 124 from the license database 114. If the participant agrees to the terms of the license 124, the license 124 may be copied to the client device 104. In this case, the license 124 may include the key with which to unlock the encrypted content item 126. The participant may then access the content item 126 subject to the limitations set forth by the license 124 stored in the client device 104. It should be appreciated that the above described DRM process is merely illustrative. Other suitable DRM processes may be utilized as contemplated by those skilled in the art.

A participant (e.g., the content creator) or other user (e.g., a broker representing the content creator) may access the interface module 118 via an interface access module 122. In one embodiment, the interface module 118 provides a website or other remote interface. In this embodiment, the interface access module 122 may be a web browser, which enables the participant to remotely access the website provided by the interface module 118. In other embodiments, the interface access module 122 may be any suitable computer application that provides the participant access to the interface module 118.

When a participant, such as the content creator, desires to access the virtual world, the participant may initiate the virtual world client module 120 to establish a session with the virtual world server module 110 via the network 108. During the session, the virtual world server module 110 may transmit data (e.g., environment layouts, avatar movements of other participants) associated with the virtual world to the virtual world client module 120. Similarly, the virtual world client module 120 may transmit data from associated input devices to the virtual world server module 110. The virtual world client module 120 in conjunction with the interface access module 122 may further interact with the interface module 118, as briefly mentioned above, to upload the participant-generated content item 126 from the client device 104 to the content database 116 for distribution in the virtual world and to create or upload the license 124 to the license database 114 to manage the distribution of the participant-generated content item 126 to other participants, manage the usage of the participant-generated content item 126 by other participants, and define the compensation the content creator is to receive from the distribution of the participant-generated content item 126.

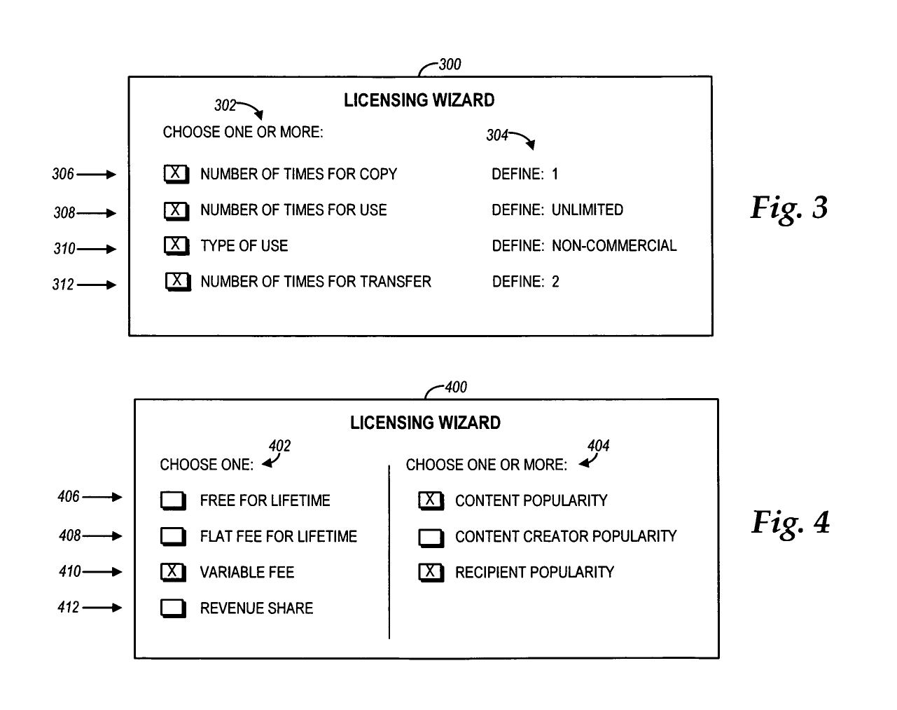

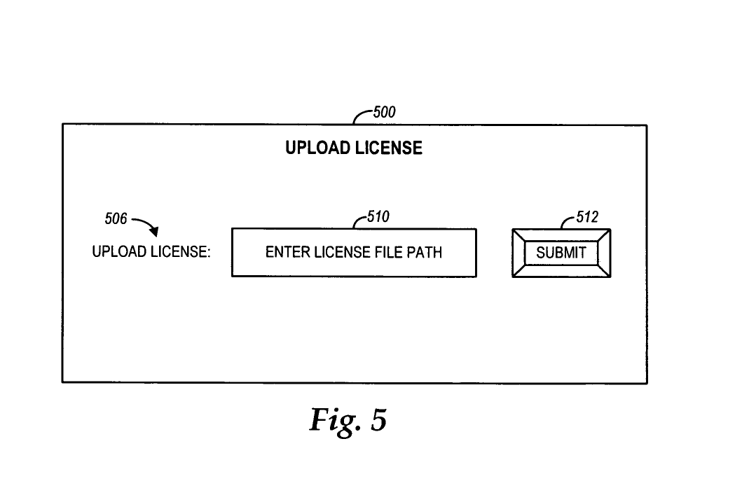

A number of exemplary screenshots of a licensing interface provided by the interface module 118 will now be presented with reference to FIGS. 2, 3, 4, and 5. It should be appreciated that the screenshots shown herein are merely illustrative. The licensing interface may be any suitable interface that enables a content creator or other user to upload the participant-generated content item 126 to be distributed within the virtual world and to create or upload the license 124 to associate with the participant-generated content item 126. In one embodiment, the license 124 is created using the licensing wizard 128, which is illustrated in FIGS. 3 and 4.

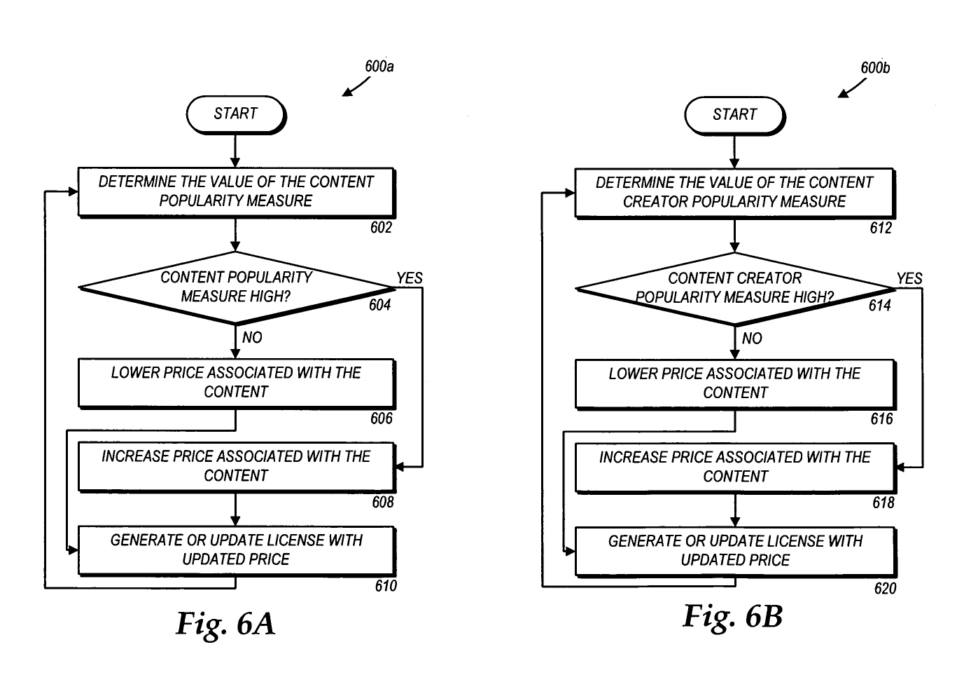

Turning now to FIG. 2, an illustrative screenshot 200 of the licensing interface provided by the interface module 118 and the interface access module 122 is shown, in accordance with one embodiment. A participant 202 may view the screenshot 200 on a display 204 operatively coupled to the client device 104. As shown in FIG. 2, the screenshot 200 includes an upload content section 206 and an interface selection 208. The upload content section 206 enables the participant 202 to upload one or more files corresponding to the participant-generated content item 126 from the client device 104 to the content database 116. In particular, the participant 202 may enter a file path and file name in a window 210 and click on a submit button 212 to initiate the upload. After the participant 202 uploads a file to the content database 116, the participant 202 can associate a license, such as the license 124, with the uploaded file by choosing the licensing wizard 128 at 214 or the upload license interface 130 at 216 in the interface selection 208. If the participant 202 chooses the licensing wizard 128, the interface module 118 may provide an interface as described in greater detail below with reference to FIGS. 3 and 4. On the other hand, if the participant 202 chooses the upload license interface 130, the interface module 118 may provide an interface as described in greater detail below with reference to FIG. 5.

Turning now to FIGS. 3 and 4, a first illustrative screenshot 300 and a second illustrative screenshot 400 of the licensing wizard 128 provided by the interface module 118 and the interface access module 122 are shown, in accordance with one embodiment. Referring to FIG. 3, the first screenshot 300 shows a portion of the licensing wizard 128 in which the participant 202 can define a range of allowable uses by other participants for the participant-generated content item 126 stored in the content database 116. In particular, the interface module 118 may provide a plurality of possible criteria with which to specify or limit the usage of the participant-generated content item 126. Upon selecting one or more applicable criteria from the plurality of possible criteria, the participant 202 may define the selected criteria based on personal preferences.

The first screenshot 300 includes a usage column 302 and a definition column 304 associated with the usage column 302. Corresponding to the usage column 302 and the definition column 304 is a first row 306, a second row 308, a third row 310, and a fourth row 312. The usage column 302 includes a number of times for copy criterion at the first row 306, a number of times for use criterion at the second row 308, a type of use criterion at the third row 310, and a number of times for transfer criterion at the fourth row 312. As used herein, the number of times for copy criterion specifies the number of times in which the participant-generated content item 126 can be copied. For example, the DRM module 106 may provide only a limited number of licenses for the participant-generated content item 126. According to the first row 306 of the definition column 304, the participant 202 has defined the number of times for copy criterion as one. As such, the participant-generated content item 126 can be copied only once. As used herein, the number of times for use criterion specifies the number of times in which the participant-generated content item 126 can be used. For example, the DRM module 106 may maintain a count for the number of times the participant-generated content item 126 is used. Once the count surpasses a threshold number, the DRM module 106 may terminate access to the participant-generated content item 126. According to the second row 308 of the definition column 304, the participant 202 has defined the number of times for use criterion as unlimited. As such, the participant-generated content item 126 has no limitation on the number of uses.

As used herein, the type of use criterion specifies whether the participant-generated content item 126 is for commercial and/or non-commercial use. The limitation of the type of use may be stated in an agreement provided to other participants prior to the purchase of the participant-generated content item 126. In this case, the other participants may purchase the participant-generated content item 126 only after agreeing the terms of the agreement. According to the third row 310 of the definition column 304, the participant 202 has defined the type of use as non-commercial. As such, the participant-generated content item 126 may not be used for commercial use. As used herein, the number of times for transfer criterion specifies the number of times the participant-generated content item 126 can be transferred from one computing device to another. For example, the DRM module 106 may maintain a count on the number of times the participant-generated content item 126 is transferred. Once the count surpasses a threshold number, the DRM module 106 may disable the transfer operation. According to the fourth row 312 of the definition column 304, the participant 202 has defined the number of times for transfer criterion as two. As such, the participant-generated content item 126 may be transferred only twice. Once the participant 202 has selected and defined the applicable criteria from the plurality of available criteria, the licensing wizard 128 proceeds to the second screenshot 400.

Referring to FIG. 4, the second screenshot 400 shows a portion of the licensing wizard 128 in which the participant 202 can define the compensation the participant 202 is to receive from the distribution of the participant-generated content item 126. In particular, the interface module 118 may provide a plurality of possible criteria with which to specify on what basis the participant 202 may be compensated. Upon selecting one or more applicable criteria from the plurality of possible criteria, the participant 202 may be compensated according to the selected criteria.

The screenshot 400 includes a compensation selection column 402 and a variable rate selection column 404. Corresponding to the compensation selection column 402 and the variable rate selection column 404 is a first row 406, a second row 408, a third row 410, and a fourth row 412. The compensation selection column 402 illustrates a number of different compensation criteria from which the participant 202 can choose. In particular, the compensation selection column 402 includes a free for lifetime criterion at the first row 406, a flat fee for lifetime criterion at the second row 408, a variable fee criterion at the third row 410, and a revenue share criterion at the fourth row 412. As used herein, the free for a lifetime criterion specifies that the participant-generated content item 126 is free for an unlimited duration. The flat fee for lifetime criterion specifies a single, unchanged rate to access the participant-generated content item 126. The variable fee criterion specifies a variable rate to access the participant-generated content item 126. For example, while the participant 202 may be compensated one amount under one circumstance, the participant 202 may be compensated by another amount under another circumstance. The variable rate may depend on any number of suitable factors specified by the interface module 118. In one example, the variable rate may be based, at least in part, on the popularity of one or more of the participant 202 generating the content item 126, the content item 126, and the other participants (hereinafter referred to as recipients) purchasing and/or accessing the participant-generated content item 126. The revenue share criterion specifies compensation in the form of revenue sharing when the participant-generated content item 126 is, for example, placed with advertising or utilized to sell a product or service. In the example shown in FIG. 4, the participant 202 has selected the variable rate criterion under the compensation selection column 402.

Upon receiving the selection of the variable rate criterion, the interface module 118 provides the variable rate selection column 404. The variable rate selection column 404 illustrates a number of popularity measures from which the participant 202 can choose. The selected popularity measures are used to determine the price charged to purchase the participant-generated content item 126. As used herein, the term “price” refers to an amount of any suitable unit of compensation including, but not limited to, real world currency, virtual world currency, and points (e.g., MICROSOFT POINTS, NINTENDO WII POINTS). In particular, the variable rate selection column 404 includes a content popularity measure at the first row 406, a content creator popularity measure at the second row 408, and a recipient popularity measure at the third row 410. As used herein, the content popularity measure refers to the popularity of the participant-generated content item 126. In one embodiment, content popularity measure is higher if the participant-generated content item 126 is more popular and is lower if the participant-generated content item 126 is less popular. The popularity of the participant-generated content item 126 may be determined based on any suitable factors including, but not limited to, the number of participants purchasing the participant-generated content item 126 and the frequency with which the participants access the participant-generated content item 126 after it is purchased. The content creator popularity measure refers to the popularity of the participant 202 who created the participant-generated content item 126. The recipient popularity measure refers to the popularity of other participants who purchase and/or access the participant-generated content item 126. In the example shown in FIG. 4, the participant 202 has selected the content popularity measure and the recipient popularity measure under the variable rate selection column 404.

The popularity of the content creator and the recipient may be based on any suitable factors related to the popularity of participants. In particular, the popularity of the content creator and the recipient may be determined based on a variety of viewpoints, such as the viewpoints of advertisers, the administrator of the virtual world, and other participants in the virtual world. These viewpoints may overlap and/or differ. For example, an advertiser may consider the content creator and the recipient to be popular if they have a large network of friends, chat frequently (i.e., a high chat frequency), roam over a large area within the virtual world, log into or access the virtual world frequently (i.e., a high login frequency), and the like. The administrator of the virtual world may consider the content creator and the recipient to be popular if they frequently log on to the virtual world, spend a significant amount of time within the virtual world, generate a significant amount of content (e.g., text, pictures, audio, video, avatars, virtual objects) for the virtual world, and the like. The other participants in the virtual world may consider the content creator and the recipient to be popular if they generate high quality content, which can be rated by and adopted by the other participants, productively participate (i.e., a high quality of participation) in virtual world events and games, substantially participate (i.e., a high amount of participation) in virtual world events and games, provide technical support for the other participants in the virtual world, and the like.

The popularity measures described above may be used to stimulate demand and to maximize revenue by controlling the price of the participant-generated content item 126 in accordance with one or more of the popularity measures. In one example, if the participant-generated content item 126 is less popular (e.g., the popularity of content measure is low), the licensing wizard 128 may establish a lower price for the participant-generated content item 126 in order to stimulate demand. However, as the participant-generated content item 126 increases in popularity (e.g., the content popularity measure increases), the licensing wizard 128 may increase the price of the participant-generated content item 126. In another example, if the content creator is less popular (e.g., the content creator popularity measure is low), the licensing wizard 128 may establish a lower price for the participant-generated content item 126 in order to stimulate demand. However, as the content creator increases in popularity (e.g., the content creator popularity measure increases), the licensing wizard 128 may increase the price of the participant generated content item 126. In yet another example, if the recipient is more popular (e.g., the recipient popularity measure is high), the licensing wizard 128 may establish a lower price for the participant-generated content item 126 in order to increase the demand for the participant-generated content item 126 by other participants. Based on the input the participant 202 provides the licensing wizard 128, the interface module 118 generates a license, such as the license 124. The license 124 may be embodied in computer-readable media and stored in the license database 114. In particular, the license 124 may be in the form of a schema or a suitable programming language.

Turning now to FIG. 5, an illustrative screenshot 500 of the upload license interface 130 provided by the interface module 118 and the interface access module 122 is shown, in accordance with one embodiment. The screenshot 500 includes an upload license section 506. The upload license section 506 enables the participant 202 to upload one or more licenses, such as the license 124, that were generated by the participant 202 separate from the interface module 118. In particular, the participant 202 may enter a file path and file name in a window 510 and click on a submit button 512 to initiate the upload. The license 124 may be created in the form of a schema or a suitable programming language, as previously described. Although not shown in FIGS. 2, 3, 4 and 5, the licensing interface may also include a list of previously generated and uploaded licenses from which the participant 202 can choose. In this way, the participant 202 does not need to regenerate or re-upload the license 124.

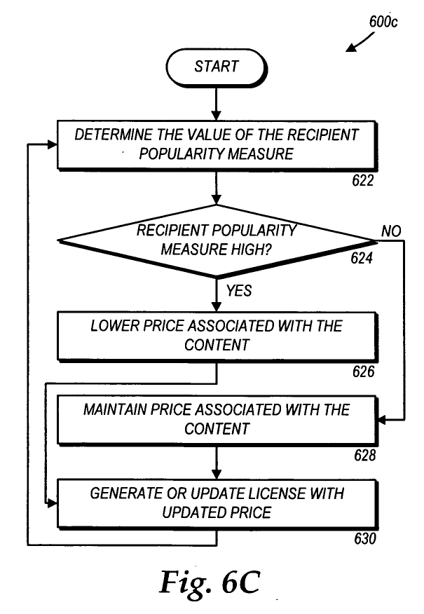

Referring now to FIGS. 6A, 6B, and 6C, additional details will be provided regarding popularity-based licensing of participant-generated content, such as the participant-generated content item 126. In particular, FIGS. 6A, 6B, and 6C illustrate exemplary operations of the licensing wizard 128 for determining and adjusting a price of the participant-generated content item 126 in accordance with one or more popularity measures provided by the popularity module 132. When presented with the licensing wizard 128, the participant 202 or other user may select one or more of the content popularity measure, the content creator popularity measure, and the recipient popularity measure. If the content popularity measure is selected, the licensing wizard 128 may determine and adjust the price of the participant-generated content item 126 in accordance with a routine 600a illustrated in FIG. 6A. If the content creator popularity measure is selected, the licensing wizard 128 may determine and adjust the price of the participant-generated content item 126 in accordance with a routine 600b illustrated in FIG. 6B. If the recipient popularity measure is selected, the licensing wizard 128 may determine and adjust the price of the participant-generated content item 126 in accordance with a routine 600c illustrated in FIG. 6C.

It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof. It should be appreciated that more or fewer operations may be performed than shown in the figures and described herein. These operations may also be performed in a different order than those described herein.

Referring to FIG. 6A, the routine 600a begins at operation 602 where the popularity module 132 determines the value of the content popularity measure. In one embodiment, a higher content popularity measure indicates a higher popularity of the participant-generated content item 126, while a lower content popularity measure indicates a lower popularity of the participant-generated content item 126. The routine 600a continues to operation 604 where the popularity module 132 determines whether the value of the content popularity measure is higher than a threshold value. If the value of the content popularity measure is lower than the threshold value, then the routine 600a continues to operation 606 where the price of the participant-generated content item 126 is lowered by a given amount. By lowering the price of the participant-generated content item 126 when the content popularity measure is lower, the popularity for the participant-generated content item 126 may be increased as a result of increased demand and/or distribution of the participant-generated content item 126. On the other hand, if the value of the content popularity measure is higher than the threshold value, then the routine 600a continues to operation 608 where the price of the participant-generated content item 126 is increased by a given amount. By increasing the price of the participant-generated content item 126 when the content popularity measure is higher, revenue may be maximized by charging a premium price to purchase and access the participant-generated content item 126 relative to the popularity of the participant-generated content item 126.

Once the price of the participant-generated content item 126 has been updated (i.e., lowered or raised), the routine 600a continues to operation 610 where the licensing wizard 128 generates or updates the license 124 with the updated price. After the license 124 is generated or updated, the routine 600a returns to operation 602 where the popularity module 132 determines again the value of the content popularity measure. As illustrated in FIG. 6A, the operations 602, 604, 606, 608, and 610 may be repeated such that the price of the participant-generated content item 126 is dynamically updated to reflect any variations in the content popularity measure. As previously mentioned, the popularity module 132 may determine the content popularity measure based on any suitable factors related to the popularity of the participant-generated content item 126.

Referring to FIG. 6B, the routine 600b begins at operation 612 where the popularity module 132 determines the value of the content creator popularity measure. In one embodiment, a higher content creator popularity measure indicates a higher popularity of the participant 202 who has created the participant-generated content item 126, while a lower content popularity measure indicates a lower popularity of the participant 202 who has created the participant-generated content item 126. The routine 600b continues to operation 614 where the popularity module 132 determines whether the value of the content creator popularity measure is lower than a threshold value. If the value of the content creator popularity measure is lower than the threshold value, then the routine 600b continues to operation 616 where the price of the participant-generated content item 126 is lowered by a given amount. The price of the participant-generated content item 126 is lowered under the presumption that demand for the participant-generated content item 126 may be lower because the popularity of the content creator is lower. As such, by lowering the price of the participant-generated content item 126 when the content creator popularity measure is lower, demand for the participant-generated content item 126 may be increased. On the other hand, if the value of the content creator popularity measure is higher than the threshold value, then the routine 600b continues to operation 618 where the price of the participant-generated content item 126 is increased by a given amount. Similar to the above, the price of the participant-generated content item 126 is increased under the presumption that demand for the participant-generated content item 126 may be higher because the popularity of the content creator is higher. As such, by increasing the price of the participant-generated content item 126 when the content creator popularity measure is higher, revenue may be maximized by charging a premium price to purchase the participant-generated content item 126 relative to the popularity of the content creator.

Once the price of the participant-generated content item 126 has been updated (i.e., lowered or raised), the routine 600b continues to operation 620 where the licensing wizard 128 generates or updates the license 124 with the updated price. After the license 124 is generated or updated, the routine 600b returns to operation 612 where the popularity module 132 determines again the value of the content creator popularity measure. As illustrated in FIG. 6B, the operations 612, 614, 616, 618, and 620 may be repeated such that the price of the participant-generated content item 126 is dynamically updated to reflect any variations in the content creator popularity measure. As previously mentioned, the popularity module 132 may determine the content creator popularity measure based on any suitable factors related to the popularity of the content creator.

Referring to FIG. 6C, the routine 600c begins at operation 622 where the popularity module 132 determines the value of the recipient popularity measure. In one embodiment, a higher recipient popularity measure indicates a higher popularity of the participant who is purchasing the participant-generated content item 126, while a lower recipient popularity measure indicates a lower popularity of the of the participant who is purchasing and/or accessing the participant-generated content item 126. The routine 600c continues to operation 624 where the popularity module 132 determines whether the value of the recipient popularity measure is higher than a threshold value. If the value of the recipient popularity measure is lower than the threshold value, then the routine 600c continues to operation 626 where the price of the participant-generated content item 126 is lowered by a given amount. The price of the participant-generated content item 126 is lowered under the presumption that if the participant-generated content item 126 is viewed in the virtual world as being associated with the popular recipient, then demand for the participant-generated content item 126 will increase. By lowering the price of the participant-generated content item 126 when the recipient popularity measure is higher, the recipient may be more inclined to purchase the participant-generated content item 126. On the other hand, if the value of the recipient popularity measure is lower than the threshold value, then the routine 600b continues to operation 628 where the price of the participant-generated content item 126 remains the same. In this case, the recipients who are not as popular pay the regularly assigned price for the participant-generated content item 126.

Once the price of the participant-generated content item 126 has been updated (i.e., lowered or raised), the routine 600c continues to operation 630 where the licensing wizard 128 generates or updates the license 124 with the updated price. After the license 124 is generated or updated, the routine 600c returns to operation 622 where the popularity module 132 determines again the value of the recipient popularity measure. As illustrated in FIG. 6c, the operations 622, 624, 626, 628, and 630 may be repeated such that the price of the participant-generated content item 126 is dynamically updated to reflect any variations in the recipient popularity measure. As previously mentioned, the popularity module 132 may determine the recipient popularity measure based on any suitable factors related to the popularity of the recipient.

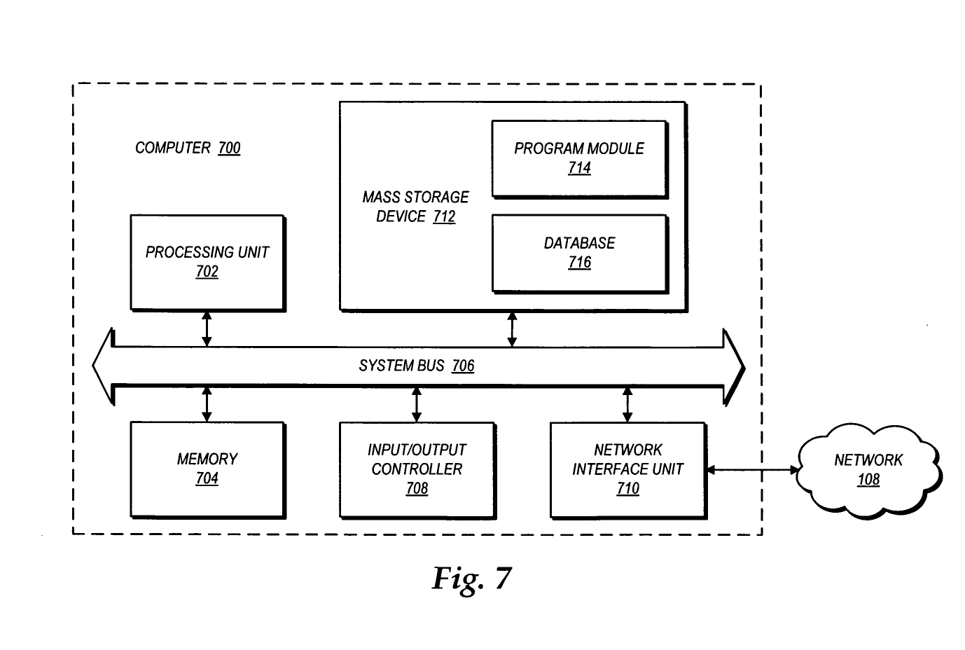

Referring now to FIG. 7, an exemplary computer architecture diagram showing aspects of a computer 700 is illustrated. Examples of the computer 700 may include the server computer 102 and the client device 104. The computer 700 includes a processing unit 702 (“CPU”), a system memory 704, and a system bus 706 that couples the memory 704 to the CPU 702. The computer 700 further includes a mass storage device 712 for storing one or more program modules 714 and one or more databases 716. Examples of the program modules 714 may include the interface module 118, the interface access module 122, and the DRM module 106. Examples of the databases 716 may include the license database 114 and the content database 116. The mass storage device 712 is connected to the CPU 702 through a mass storage controller (not shown) connected to the bus 706. The mass storage device 712 and its associated computer-readable media provide non-volatile storage for the computer 700. Although the description of computer-readable media contained herein refers to a mass storage device, such as a hard disk or CD-ROM drive, it should be appreciated by those skilled in the art that computer-readable media can be any available computer storage media that can be accessed by the computer 700.

By way of example, and not limitation, computer-readable media may include volatile and non-volatile, removable and non-removable media implemented in any method or technology for storage of information such as computer-readable instructions, data structures, program modules, or other data. For example, computer-readable media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 700.

According to various embodiments, the computer 700 may operate in a networked environment using logical connections to remote computers through a network such as the network 108. The computer 700 may connect to the network 108 through a network interface unit 710 connected to the bus 706. It should be appreciated that the network interface unit 710 may also be utilized to connect to other types of networks and remote computer systems. The computer 700 may also include an input/output controller 708 for receiving and processing input from a number of input devices (not shown), including a keyboard, a mouse, a microphone, and a game controller. Similarly, the input/output controller 708 may provide output to a display or other type of output device (not shown).

Based on the foregoing, it should be appreciated that technologies for popularity-based licensing of user-generated content are presented herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A method for providing popularity-based licensing of user-generated content, the method comprising:
receiving a selection of a popularity measure;
determining a value of the popularity measure;
determining a price of a user-generated content item based on the value of the popularity measure; and
generating a license including the price of the user-generated content item.

2. The method of claim 1, wherein receiving a selection of a popularity measure comprises receiving the selection of the popularity measure from a list of a plurality of popularity measures.

3. The method of claim 2, wherein the list of the plurality of popularity measures comprises one or more of a content item popularity measure indicating a popularity of the user-generated content item, a content creator popularity measure indicating a popularity of a first participant who created the user-generated content item, and a recipient popularity measure indicating a popularity of a second participant who is purchasing or accessing the user-generated content item.

4. The method of claim 1, wherein determining a value of the popularity measure comprises determining a value of a content item popularity measure indicating a popularity of the user-generated content item.

5. The method of claim 4, wherein determining a value of the content item popularity measure comprises determining the value of the content item popularity measure based on one or more of a number of participants who purchase the user-generated content item and a frequency with which participants access the user-generated content item.

6. The method of claim 1, wherein determining a value of the popularity measure comprises determining a value of a content creator popularity measure indicating a popularity of a participant who created the user-generated content item based on a popularity of the content creator with respect to an advertiser.

7. The method of claim 6, wherein determining a value of a content creator popularity measure indicating a popularity of a participant who created the user-generated content item based on a popularity of the content creator with respect to an advertiser comprises determining the content creator popularity measure based on one or more of a number of friends associated with the participant, an amount of area roamed in a virtual world by the participant, and a chat frequency of the participant.

8. The method of claim 1, wherein determining a value of the popularity measure comprises determining a value of a content creator popularity measure indicating a popularity of a participant who created the user-generated content item based on a popularity of the content creator with respect to an administrator of a virtual world.

9. The method of claim 8, wherein determining a value of a content creator popularity measure indicating a popularity of a participant who created the user-generated content item based on a popularity of the content creator with respect to an administrator of a virtual world comprises determining the value of the content creator popularity measure based on one or more of a login frequency of the participant, an amount of time spent by the participant in the virtual world, and an amount of content created by the participant for the virtual world.

10. The method of claim 1, wherein determining a value of the popularity measure comprises determining a value of the popularity measure comprises determining a value of a content creator popularity measure indicating a popularity of a participant who created the user-generated content item based on a popularity of the content creator with respect to other participants of a virtual world.

11. The method of claim 1, wherein determining a value of the popularity measure comprises determining a value of a content creator popularity measure indicating a popularity of a participant who created the user-generated content item based on a popularity of the content creator with respect to other participants of a virtual world comprises determining the value of the content creator popularity measure based on one or more of a quality of content created by the participant for the virtual world, an amount of participation by the participant in the virtual world, an amount of technical support provided by the participant for other participants in the virtual world, and a level of adoption of content created by the participant in the virtual world.

12. The method of claim 1, wherein determining a value of the popularity measure comprises determining a value of a recipient popularity measure indicating a popularity of a participant who is purchasing or accessing the user-generated content item.

13. The method of claim 12, wherein determining a value of a recipient popularity measure indicating a popularity of a participant who is purchasing or accessing the user-generated content item comprises determining the value of the recipient popularity measure based on a popularity of the participant with respect to one or more of an advertiser, an administrator of a virtual world, and other participants of the virtual world.

14. A computer-readable medium having computer-executable instructions stored thereon which, when executed by a computer, cause the computer to perform the method of claim 1.

15. A method for providing popularity-based licensing of user-generated content, the method comprising:
receiving a selection of a popularity measure;
determining a value of the popularity measure;
adjusting a price of a user-generated content item to stimulate demand or maximize revenue of the user-generated content item based on the value of the popularity measure with respect to a threshold; and
updating a license including the price of the user-generated content item.

16. The method of claim 15, wherein determining a value of the popularity measure comprises determining a value of a content popularity measure indicating a popularity of the user-generated content item; and wherein adjusting a price of a user-generated content item to stimulate demand or maximize revenue of the user-generated content item based on the value of the popularity measure with respect to a threshold comprises increasing the price of the user-generated content item in response to the value of the content popularity measure being above the threshold, and lowering the price of the user-generated content item in response to the value of the content popularity measure being below the threshold.

17. The method of claim 15, wherein determining a value of the popularity measure comprises determining a value of a content creator popularity measure indicating a popularity of a participant who created the user-generated content item; and wherein adjusting a price of a user-generated content item to stimulate demand or maximize revenue of the user-generated content item based on the value of the popularity measure with respect to a threshold comprises increasing the price of the user-generated content item in response to the value of the content creator popularity measure being above the threshold, and lowering the price of the user-generated content item in response to the value of the content creator popularity measure being below the threshold.

18. The method of claim 15, wherein determining a value of the popularity measure comprises determining a value of a recipient popularity measure indicating a popularity of a participant who is purchasing or accessing the user-generated content item; and wherein adjusting a price of a user-generated content item to stimulate demand or maximize revenue of the user-generated content item based on the value of the popularity measure with respect to a threshold comprises lowering the price of the user-generated content item in response to the value of the recipient popularity measure being above the threshold.

19. A computer-readable medium having computer-executable instructions stored thereon which, when executed by a computer, cause the computer to perform the method of claim 15.

20. A computer-readable medium having computer-executable instructions stored thereon which, when executed by a computer, cause the computer to:
receiving a selection of one or more of a content popularity measure indicating a popularity of a user-generated content item, a content creator popularity measure indicating a popularity of a first participant who created the user-generated content item, and a recipient popularity measure indicating a popularity of a second participant who is purchasing the user-generated content item;
in response to receiving the selection of the content popularity measure,
determining a value of the content popularity measure, increasing a price of the user-generated content item in response to the value of the content popularity measure being above a first threshold, and lowering the price of the user-generated content item in response to the value of the content popularity measure being below the first threshold;
in response to receiving the selection of the content creator popularity measure,
determining a value of the content creator popularity measure, increasing the price of the user-generated content item in response to the value of the content creator popularity measure being above a second threshold, and lowering the price of the user-generated content item in response to the value of the content creator popularity measure being below the second threshold;
in response to receiving the selection of the recipient popularity measure,
determining a value of the recipient popularity measure, and lowering the price of the user-generated content item in response to the value of the recipient popularity measure being above a third threshold; and
generating a license including the price of the user-generated content item.
